(19) United States
(12) Patent Application Publication
(10) Pub. No.: US 2016/0166977 A1
(43) Pub. Date: Jun. 16, 2016

(54) GAS-ASSISTED STRIPPING OF LIQUID SOLVENTS FOR CARBON CAPTURE

(71) Applicant: John Timothy Cullinane, Montgomery, TX (US)

(72) Inventor: John Timothy Cullinane, Montgomery, TX (US)

(73) Assignee: ExxonMobil Research and Engineering Company, Annandale, NJ (US)

(21) Appl. No.: 14/941,817

(22) Filed: Nov. 16, 2015

Related U.S. Application Data
(60) Provisional application No. 62/090,041, filed on Dec. 10, 2014.

(51) Int. Cl. B01D 53/14; F23J 15/04

(52) U.S. Cl. CPC B01D 53/1425; B01D 53/1475; F23J 15/04; B01D 2252/204

(57) ABSTRACT

The embodiments of the disclosure relate generally to absorbent processes, systems, and methods. The disclosure includes the use of a combination of thermal regeneration and gas assisted stripping to convert a rich CO₂ absorbent to a lean CO₂ absorbent via an intermediate semi-lean CO₂ absorbent. The system includes a regenerator and a stripper to convert the rich CO₂ absorbent to the lean CO₂ absorbent, and can further include a combustor and an absorber. A fuel gas can be used as the stripping gas, thereby producing a CO₂-rich fuel gas, which can be recycled to a combustor to reclaim the fuel value.

### CROSS-REFERENCE TO RELATED APPLICATIONS

This application claims priority to U.S. Provisional Application Ser. No. 62/090,041 filed Dec. 10, 2014, herein incorporated by reference in its entirety.

### TECHNICAL FIELD

The various embodiments of the disclosure relate generally to a two-stage regeneration scheme utilizing heat and stripping gas to remove CO₂ from an absorbent. The portion of CO₂ removed with the stripping gas can be recycled to the combustion step in an effect similar to a dilution gas (e.g. exhaust gas recycle).

### BACKGROUND OF THE INVENTION

Currently, commercial-ready technology for CO₂ removal from flue gas is based on capturing the CO₂ in an absorber/stripper process using a circulated amine solvent. The primary obstacle to widespread implementation of this technology is the cost of CO₂ capture. Estimates suggest that up to ⅓ of the total power output of the plant would be consumed by the capture process. The conventional process is based on amine treatment, where a lean amine (amine largely devoid of CO₂) is pumped into the top of an absorber tower that is filled with packing or trays. Flue gas flows into the bottom of the tower and countercurrently contacts the downward flowing amine. The amine chemically absorbs the CO₂ from the flue gas. Treated gas that is largely depleted of CO₂ exits the top of the tower and rich amine (amine containing the absorbed CO₂) leaves the bottom of the tower. The rich amine is pumped to a regenerator where heat is applied in a reboiler at the bottom of the column. The heat releases CO₂ from the solvent, generating the lean amine for recycle to the absorber. A mixture of water vapor and CO₂ countercurrently flows up the column, providing mass transfer throughout the packed section. The concentrated CO₂ stream exits the top of the column and can be compressed for sequestration or pipeline transport.

In the conventional configuration, the process is independent of the power cycle with no advantageous integrations. The absorber typically operates between 40 and 70° C. while the regenerator operates at 120-140° C. Thus, a significant portion of the energy consumed by the process is from sensible and latent heat requirements imposed by the thermal swing, which reduces the net amount of power produced by the power plant. While the low pressure steam generated by the power plant can be used as the heat source for the reboiler, the energy recovery is still inefficient.

There continues to be increasing interest in capturing CO₂ from the flue gas of power plants. But as discussed, the conventional process configurations used for CO₂ removal are challenged by high cost. The volume of flue gas is large, requiring large equipment to treat. CO₂ is difficult to efficiently capture due to the low concentration of CO₂ and the low pressure of the raw flue gas. The corresponding circulation rate of the amine is large, resulting in a large parasitic power consumption from the power plant. Better methods of CO₂ consumption with reduced costs are desirable.

### BRIEF SUMMARY

The various embodiments of the disclosure relate generally to absorbent processes, systems, and methods.

An embodiment of the disclosure can be a system for removing carbon dioxide (CO₂) from a CO₂-absorbent. The system can include a regenerator configured to remove a portion of CO₂ from a CO₂-absorbent to produce a semi-lean CO₂-absorbent. The system can include a stripper configured to contact at least a portion of a fuel gas with the semi-lean CO₂-absorbent to remove at least a portion of the CO₂ from the semi-lean CO₂-absorbent to produce a lean absorbent and a CO₂-enriched fuel gas. In some embodiments, the regenerator can be configured to thermally remove a portion of the CO₂ from the CO₂-absorbent to produce the semi-lean CO₂-absorbent.

In an embodiment, the system can further include an absorber configured to contact at least a portion of a flue gas with an absorbent to produce the CO₂-absorbent. In some instances, the system can include at least one cooler configured to reduce the temperature of at least one of the semi-lean CO₂-absorbent and the lean absorbent to produce at least one of a cooled semi-lean CO₂-absorbent and a cooled lean absorbent, and the absorber is configured to receive at least one of the cooled semi-lean CO₂-absorbent and the cooled lean absorbent.

In an embodiment, the absorber in the system can be configured to contact at least a portion of the flue gas with at least one of a semi-lean CO₂-absorbent and a lean absorbent to produce a CO₂-absorbent. The system can also include a combustor configured to produce the flue gas. The combustor can also be configured to receive the CO₂-enriched fuel gas. The absorbent can be an amine. The fuel gas can be a natural gas. In some embodiments, the semi-lean adsorbent can be about 5 to about 30% of the cyclic capacity of the absorbent, or about 5 to about 25% of the cyclic capacity of the absorbent.

An embodiment of the disclosure can also be a method for removing carbon dioxide (CO₂) from a CO₂-absorbent, including removing a portion of CO₂ from the CO₂-absorbent to produce a semi-lean CO₂-absorbent; and contacting a fuel gas with the semi-lean CO₂-absorbent to remove at least a portion of the CO₂ from the semi-lean CO₂-absorbent to produce a lean absorbent and a CO₂-enriched fuel gas. The removing a portion of CO₂ from the CO₂-absorbent to produce the semi-lean CO₂-absorbent can include heating the CO₂-absorbent. The method can also include combusting at least one of a fuel gas and the CO₂-enriched fuel gas to produce a flue gas. In an embodiment, the method can further including contacting at least a portion of the flue gas with an absorbent to produce the CO₂-absorbent. As with the system, the absorbent can be an amine. And the fuel gas can be a natural gas.

In some embodiment, removing a portion of CO₂ from the CO₂-absorbent to produce a semi-lean CO₂-absorbent can include converting the CO₂-adsorbent having about 95% to about 100% of the cyclic capacity of the absorbent to the semi-lean adsorbent having about 5% to about 30% of the cyclic capacity of the absorbent, or converting the CO₂-adsorbent having about 95% to about 100% of the cyclic capacity of the absorbent to the semi-lean adsorbent having about 5% to about 25% of the cyclic capacity of the absorbent.

An embodiment of the disclosure can also be a system for removing carbon dioxide from a flue gas. The system can include a combustor configured to produce a flue gas, an absorber configured to contact at least a portion of the flue gas with an absorbent to produce a CO₂-absorbent, a regenerator configured to remove a portion of CO₂ from the CO₂-absorbent to produce a semi-lean CO₂-absorbent; and a stripper configured to contact a fuel gas with the semi-lean CO₂-absorbent to remove at least a portion of the CO₂ from the semi-lean CO₂-absorbent to produce a lean absorbent and a CO₂-enriched fuel gas. The combustor can be further configured to receive the CO₂-enriched fuel gas, and the absorber can be further configured to receive the lean absorbent. In some embodiments, the regenerator is configured to thermally remove a portion of the CO₂ from the CO₂-absorbent to produce the semi-lean CO₂-absorbent. In some embodiments, the semi-lean adsorbent can be about 5 to about 30% of the cyclic capacity of the absorbent, or about 5 to about 25% of the cyclic capacity of the absorbent.

An embodiment of the disclosure can also be a method for removing carbon dioxide from a flue gas, including contacting at least a portion of a flue gas with an absorbent to produce a CO₂-absorbent, removing a portion of CO₂ from the CO₂-absorbent to produce a semi-lean CO₂-absorbent; and contacting a fuel gas with the semi-lean CO₂-absorbent to remove at least a portion of the CO₂ from the semi-lean CO₂-absorbent to produce a lean absorbent and a CO₂-enriched fuel gas. The method can also include combusting at least one of the CO₂-enriched fuel gas and a lean fuel gas to produce the flue gas. The removing a portion of CO₂ from the CO₂-absorbent to produce the semi-lean CO₂-absorbent can include heating the CO₂-absorbent.

In an embodiment, the removing a portion of CO₂ from the CO₂-absorbent to produce a semi-lean CO₂-absorbent can include converting the CO₂-adsorbent having about 95% to about 100% of the cyclic capacity of the absorbent to the semi-lean adsorbent having about 5% to about 30% of the cyclic capacity of the absorbent, or can include converting the CO₂-adsorbent having about 95% to about 100% of the cyclic capacity of the absorbent to the semi-lean adsorbent having about 5 to about 25% of the cyclic capacity of the absorbent.

An embodiment of the disclosure can be a system for removing carbon dioxide from a rich CO₂-absorbent which includes a regeneration stage and a stripping stage. The regeneration stage can be configured to thermally remove at least a portion of the CO₂ from the CO₂-absorbent. The stripping stage can be configured to contact a stripping gas with the CO₂-absorbent to remove at least a portion of the CO₂ as a CO₂-stripping gas mixture, such that the rich CO₂-absorbent mixture is converted to a lean absorbent via a semi-lean CO₂-absorbent. In some embodiments, the stripping gas is a fuel gas.

In an embodiment, the regeneration stage can precede the stripping stage, and the regeneration stage can remove CO₂ and can convert the rich CO₂-absorbent to the semi-lean CO₂-absorbent, and the stripping stage can convert the semi-lean CO₂-absorbent to the lean absorbent. In that case, the semi-lean CO₂-absorbent can be about 5 to about 30% of the cyclic capacity of the adsorbent.

In an embodiment, the stripping stage can precede regeneration stage, and the stripping stage can remove CO₂ and can convert the rich CO₂-absorbent to the semi-lean CO₂-absorbent, and the regeneration stage can convert the semi-lean CO₂-absorbent to the lean absorbent. In that case, the semi-lean CO₂-absorbent can be about 70 to about 95% of the cyclic capacity.

In some embodiments, the system can further include an absorber configured to contact at least a portion of a flue gas with an absorbent to produce the CO₂-absorbent. The system can also further comprising a combustor configured to produce the flue gas.

### BRIEF DESCRIPTION OF THE DRAWINGS

FIG. 1 illustrates a standard absorption-desorption, according to aspects of the prior art.

FIG. 2 illustrates a gas assisted stripping process, in accordance with an exemplary embodiment of the disclosure.

FIG. 3 illustrates another gas assisted stripping process, in accordance with an exemplary embodiment of the disclosure.

FIG. 4 illustrates a system for gas assisted stripping, in accordance with an exemplary embodiment of the disclosure.

FIG. 5 illustrates another system for gas assisted stripping, in accordance with an exemplary embodiment of the disclosure.

FIG. 6 illustrates an exemplary industrial process diagram applying gas assisted stripping, in accordance with an exemplary embodiment of the disclosure.

FIG. 7 illustrates an exemplary industrial process diagram applying gas assisted stripping, in accordance with an exemplary embodiment of the disclosure.

FIG. 8 illustrates an exemplary industrial process diagram applying gas assisted stripping, in accordance with an exemplary embodiment of the disclosure.

FIG. 9 illustrates a series of CO₂ concentration and partial pressure curves, as applied using an exemplary embodiment of the disclosure.

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

A method and system are disclosed that include gas assisted stripping of liquid solvents for carbon dioxide capture and removal. The disclosure can include a two-stage regeneration scheme, which includes one stage that utilizes heat to strip CO₂ from a CO₂-absorbent mixture, and another stage that utilizes a stripping gas to remove CO₂ from a CO₂-absorbent mixture. The two stages can be used in series in order to more effectively remove CO₂ from an absorbent and thereby regenerate the absorbent at a significant cost and energy savings compared to typical systems.

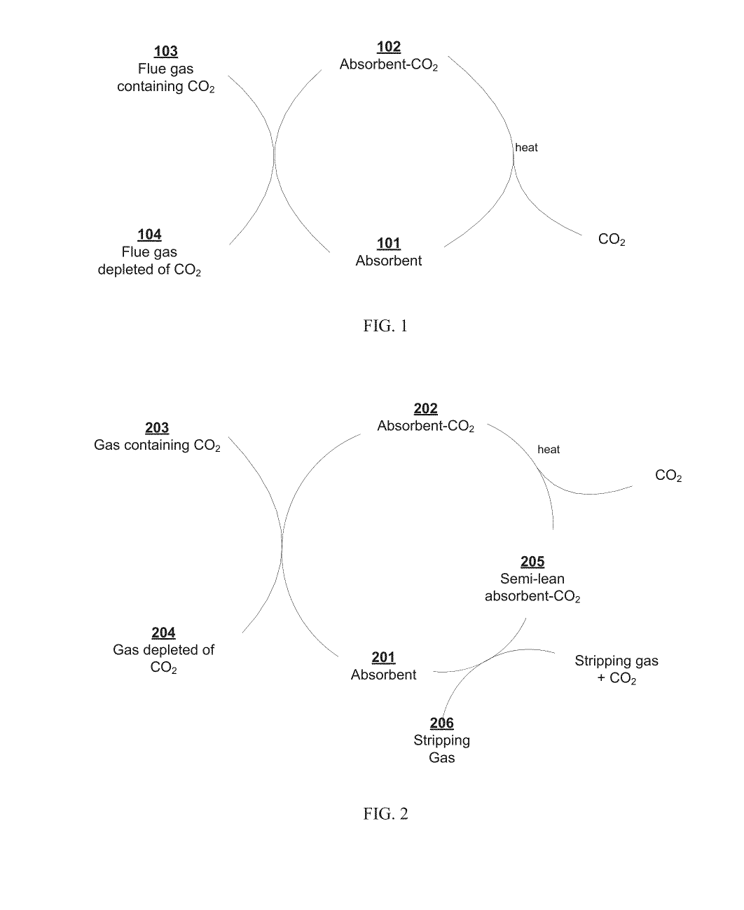

A prior art system is shown in FIG. 1. An absorbent 101 interacts with a CO₂-containing gas 103, such as a flue gas, to remove CO₂ to give a CO₂ depleted gas 104 and a CO₂-absorbent mixture 102. The mixture 102 can be regenerated by heating to evolve the CO₂ and regenerate the absorbent. As discussed above, this system requires significant energy use and capital expense primarily for heat consumption driving the thermal evolution of CO₂ from the CO₂-absorbent mixture.

In contrast, this disclosure utilizes a two-stage system and process, where a partial thermal step is conducted in conjunction with a gas stripping step. In an embodiment, the thermal step can be conducted prior to the gas stripping step, as shown in FIG. 2. An absorbent 201 can be contacted with a CO₂ containing gas 203, such as a flue gas, to remove CO₂ and give a CO₂ depleted gas 204 and CO₂-absorbent mixture 202. The CO₂-absorbent mixture can be heated in a thermal step to liberate a portion of the CO₂ as a gas, and yield a semi-lean CO₂-absorbent mixture 205. The semi-lean CO₂-absorbent mixture 205 would have some amount of absorbent that was not otherwise absorbing the CO₂ in the liquid. The mixture 205 could then be treated with a stripping gas 206 to remove the CO₂ and generate the absorbent 201 which could be fed back into the cycle.

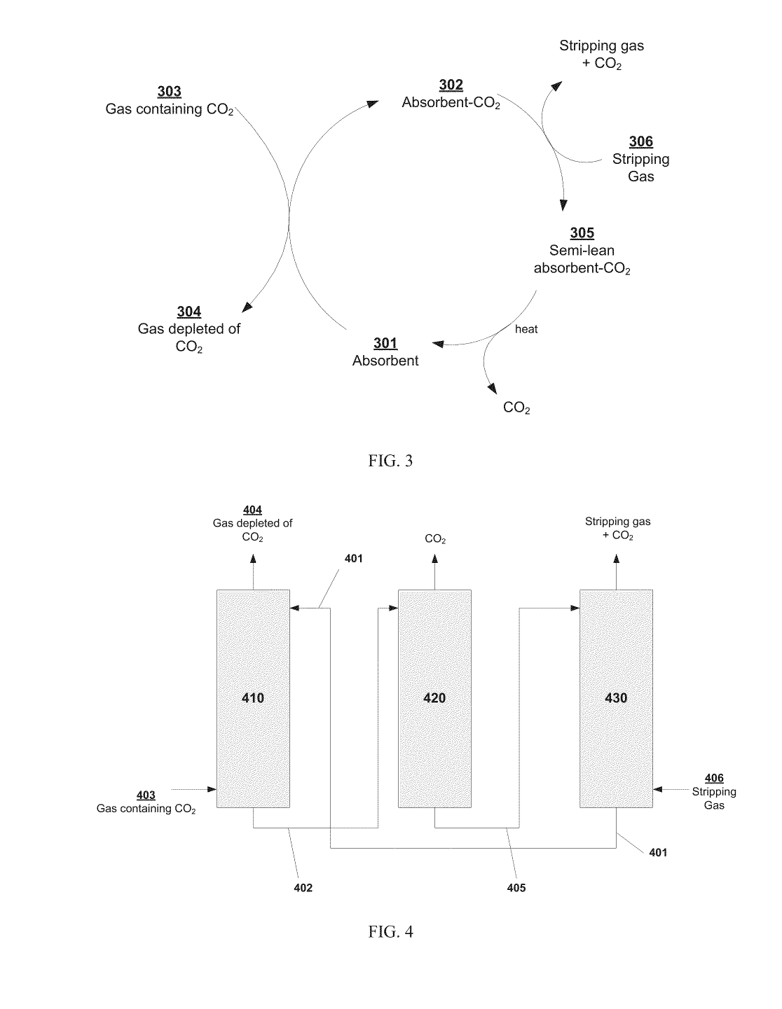

In another embodiment, the gas stripping step can be conducted prior to the thermal step, as shown in FIG. 3. An absorbent 301 can be contacted with a CO₂-containing gas 303, such as a flue gas, to remove CO₂ and give a CO₂ depleted gas 304 and CO₂-absorbent mixture 302. The CO₂-absorbent mixture can be treated with a stripping gas 306 to remove a portion of the CO₂ as a gas, and yield a semi-lean CO₂-absorbent mixture 305. The semi-lean CO₂-absorbent mixture 305 would have some amount of absorbent that was not otherwise absorbing the CO₂ in the liquid. The mixture 205 could then be heated in a thermal step to liberate at least a portion of the remaining CO₂ and generate the absorbent 301 which could be fed back into the cycle.

The disclosed system and process can also be described based on the devices that the CO₂ stripping and CO₂ desorption can be conducted in. The CO₂ desorption can be conducted in a regenerator, and the CO₂ stripping can be conducted in a stripper. An embodiment is shown in FIG. 4, where a gas containing CO₂ 403 is fed into an absorption bed 410. The absorption bed can include the lean absorbent stream 401 that mixes with and absorbs the CO₂ from the gas containing the CO₂. The CO₂ depleted gas 404 can exit from one end of the system while the rich absorbent stream 402 can exit from the system and can be fed to a regenerator 420. The regenerator can include a heat source that liberates a portion of the CO₂ from the rich absorbent stream to produce a semi-lean absorbent stream 405. The semi-lean stream can be fed to stripper 430 and mixed with at stripping gas 406 to generate a stripping gas-CO₂ mixture and the lean absorbent 401 which can be fed back to absorber 410.

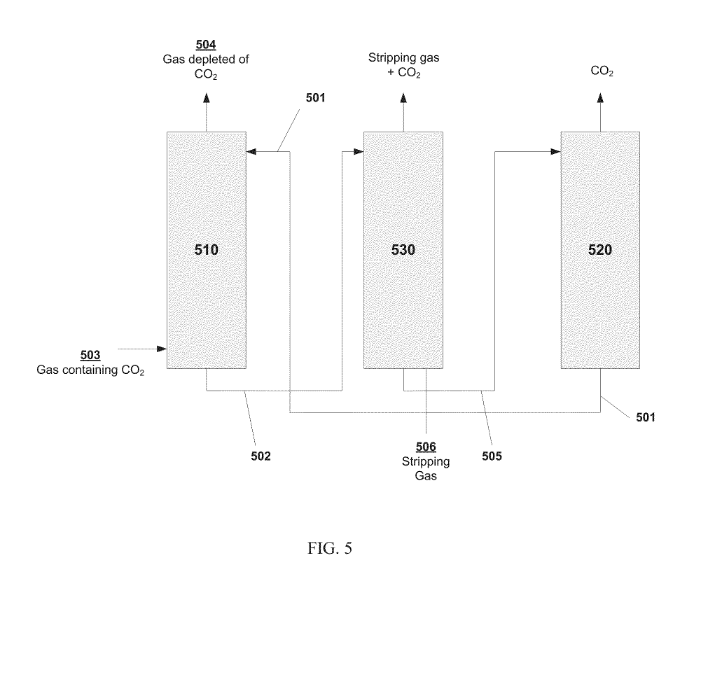

In another embodiment, shown in FIG. 5, the stripper 530 can precede the regenerator 520. The gas-containing CO₂ 503 can be fed to absorption bed 510, which can include the lean absorbent stream 501 that mixes with and absorbs the CO₂ from the gas containing the CO₂. The CO₂ depleted gas 504 and the rich absorbent stream 502 can exit from the absorption bed, and the rich stream can be fed to stripper 530, where stripping gas 506 removes a portion of the CO₂ to generate a stripping gas-CO₂ mixture and a semi-lean absorbent stream 505. The semi-lean stream can be fed to regenerator 520 to liberate CO₂ and the lean absorbent 501, which can be fed back to the absorber 510.

As noted above, one CO₂ removal step can be the regenerator and can be include a mass transfer device where heat supplies the driving force for separation. The regenerator can be similar in operation to a regenerator in a conventional process; however, because another stage is available to drive solvent regeneration, the heat required for regeneration can be lower. That is, the temperature of the regeneration step can be lower. This energy savings could be achieved by providing a smaller heat rate to the reboiler, or by providing a lower quality heat. If the vapor-liquid equilibrium of the solvent is favorable, a very low temperature (e.g. ˜100° C.) can be sufficient, which can substantially lower the sensible heat requirements of the thermal swing process. This can enable the use of low quality heat sources, lowering the parasitic draw from the power cycle.

As noted above, the other CO₂ removal step can be the stripper and can include a mass transfer device where the driving force can be provided by a stripping gas. The stripping gas can operate by reducing the concentration of CO₂ gas above the absorbent, which shifts the equilibrium to release more CO₂ from the absorbent. The mixture of stripping gas and CO₂ removed can be recycled to the combustor with an effect similar to dilution gas (e.g. exhaust gas recycle). The energy required for this type of removal is limited, assuming the availability of a suitable stripping gas. Because part of the solvent regeneration is achieved by a partial pressure effect, some of the latent heat requirements can also be reduced.

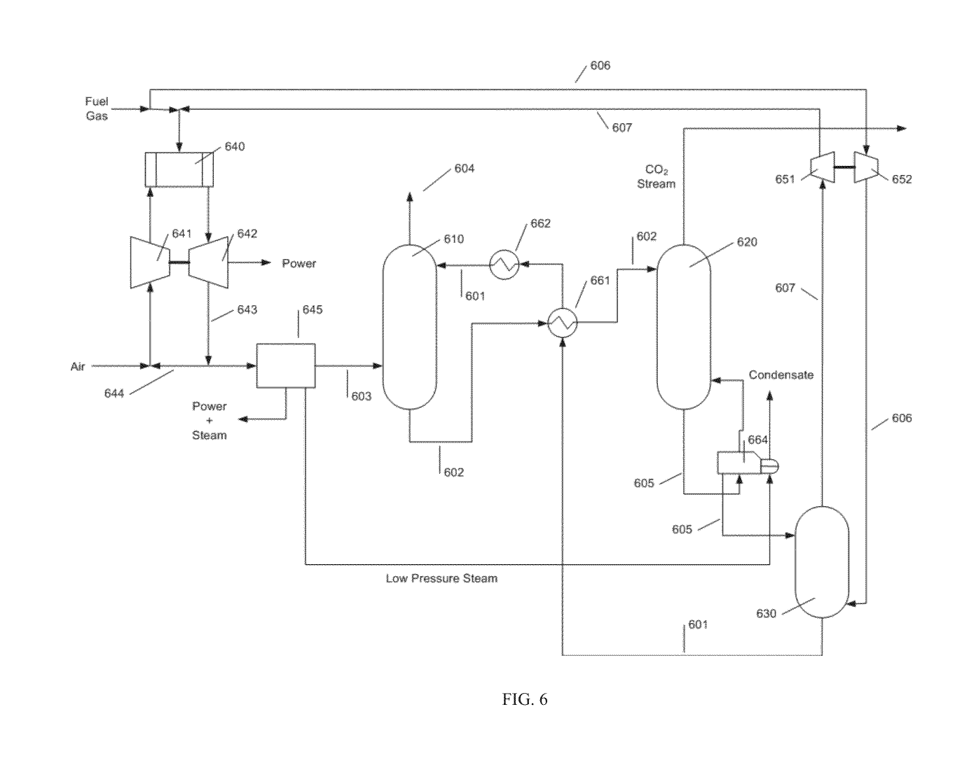

A nonlimiting example of the disclosure can be described as part of the system shown in FIG. 6. FIG. 6 includes an example where the absorbent is an amine and the stripping gas is the fuel gas used to as part of the power plant fuel, including all or a portion of the fuel gas being used as the stripping gas. Combustor 640 produces power via a turbine 642 by burning a fuel source and air fed via a compressor 641. Exhaust gas 643 exiting the turbine and can be split between an exhaust gas recycle stream 644 and conditioner 645 which can act as a heat recovery and steam generator and feed conditioning. A flue gas 603 can exit the conditioner 645 and enter absorber 610. Lean absorbent 601 fed at the top of the absorber 610 can flow countercurrently with the flue gas to produce a rich absorbent 602 out the bottom of the absorber and a vent gas 604 containing CO₂-depleted gas. The rich absorbent can pass through a cross-exchanger 661 and into a regenerator 620, where the absorbent is heated to drive off a portion of the CO₂ as a gas and the semi-lean absorbent 605 can exit out the bottom. Semi-lean absorbent can pass through reboiler 664 in combination with low pressure steam from upstream parts of the process, and move to stripper 630. Fuel gas 606 (which can optionally pass through turbine 652 to generate power for compressor 651) can enter the stripper 630 strip off the CO₂ from the semi-lean absorbent to produce a CO₂-rich fuel gas 607. The CO₂-rich fuel gas can be compressed at compressor 651 and re-blended with the feed to the combustor 640 for use in the power cycle, and its fuel value reclaimed. The rich absorbent 601 can pass through cross-exchanger 661 and cooler 662 to enter the absorber 610. Depending on the ratio of fuel gas to CO₂ in the stripper overhead, the amount of exhaust gas recycle 644 can be reduced to maintain proper fuel dilution.

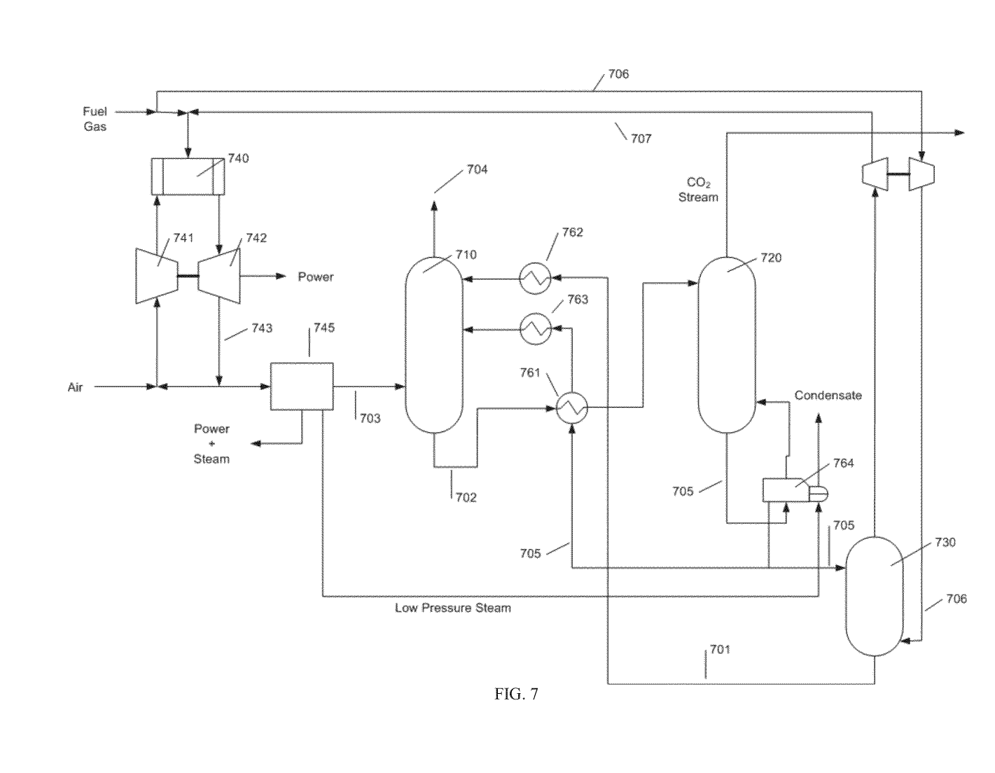

Another nonlimiting example of the disclosure can be described as part of the system shown in FIG. 7. FIG. 7 also includes an example where the absorbent is an amine and the stripping gas is a fuel gas. As in FIG. 6, a combustor 740 produces power via the turbine 742 from fuel gas and air via compressor 741. Exhaust gas 743 and conditioner 745 act before to produce the flue gas 703 which flows into the absorber 710 to interact with lean absorbent 701. This example takes advantage of the natural break in the liquid regeneration process to create a lean absorbent 701 and semi-lean absorbent 705 which are each fed back into the absorber.

The lean absorbent 701 can be recycled to the top of the absorber, while the semi-lean absorbent 705 can be recycled to a midpoint in the absorber. This lean/semi-lean configuration and its advantages are well known to those skilled in the art, but this configuration traditionally utilizes two heating stages to generate the required solvent purity. The rich absorbent can pass through a cross-exchanger 761 and into a regenerator 720, which produces the CO₂ stream and the semi-lean absorbent 705 can exit out the bottom. Semi-lean absorbent can be split to send a portion back to the absorber, and the remaining can pass through a reboiler 764 and on to stripper 730. Fuel gas 706 (optionally pass through turbine 752 to generate power for compressor 751) can enter the stripper 730 and strip off the CO₂ from the semi-lean absorbent to produce a CO₂-rich fuel gas 707. The CO₂-rich fuel gas can be re-blended with the feed to the combustor 740 for use in the power cycle.

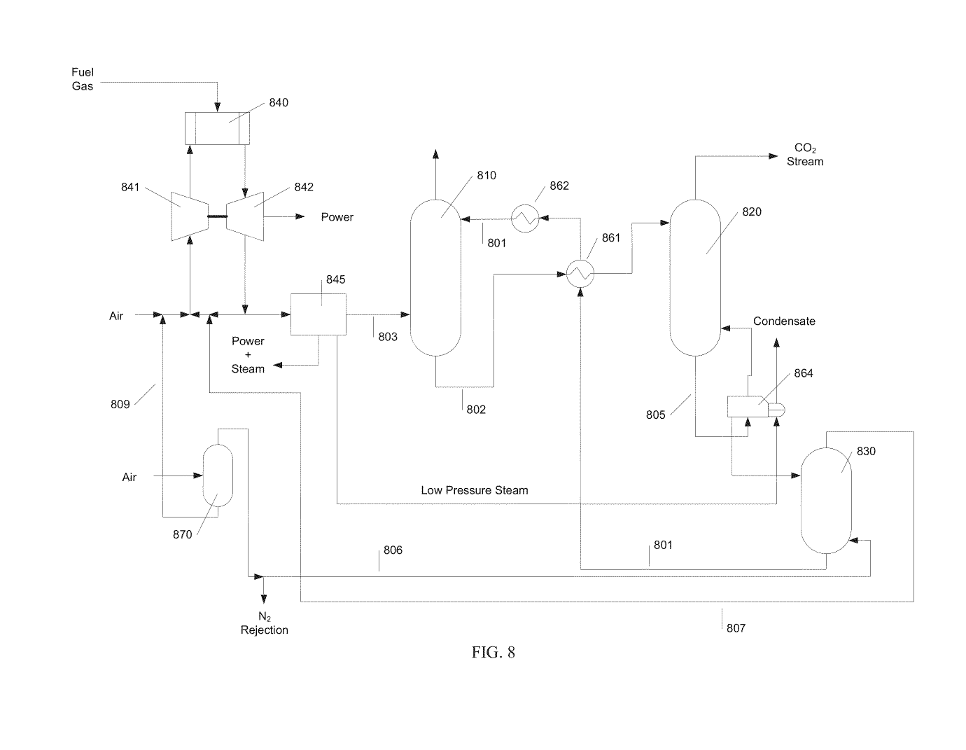

A third nonlimiting example of the disclosure can be described as part of the system shown in FIG. 8. FIG. 8 also includes an amine as the absorbent, but relies on an air stream instead of a fuel gas as the stripping gas. This example has the similar configuration as with the above two, including combustor 840, compressor 841 and turbine 842, conditioner 845 that produce the flue gas 803. Flue gas interacts the lean absorbent 801 to product the rich absorbent 802. Rich absorbent 802 proceeds to regenerator 820 to yield the CO₂ stream and semi-lean absorbent 805, which proceeds onto the stripper 830. This oxygen-enriched combined cycle process can be shown which includes the advantages of a lower fuel gas requirement and a closer approach to stoichiometric combustion, which improves capture efficiency by increasing the CO₂ content in the flue gas. An air separation system that provides enriched oxygen 809 to the air feed can achieve additional value from the air separation unit 870 by utilizing rejected nitrogen as the stripping gas 806. This stripping gas passes through the stripper 830 to interact with semi-lean amine 805 and produce the lean absorbent 801, which reenters absorber 810 after crossexchanger 861 and cooler 862. The N₂/CO₂ mixture 807 produced in the stripper can be recycled back to the combustor. Because only a slip stream of N₂ is used as the stripping gas, the combustion cycle can still be operated with enriched oxygen.

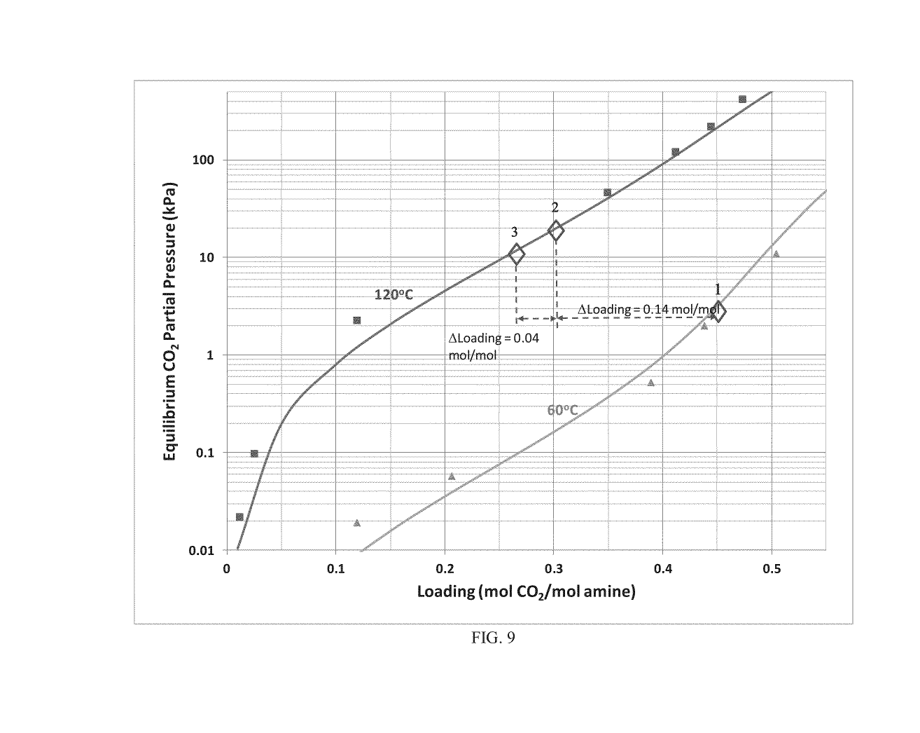

Without wishing to be bound by theory, the disclosure can operate by capitalizing on the CO₂ partial pressures at different temperatures and the ability to remove additional CO₂ by reducing the partial pressure without further changing temperatures. By way of example, data from Jou, F. Y. et al., (“The solubility of CO₂ in a 30 mass percent monoethanolamine solution.” Canadian Journal of Chemical Engineering, 73 (1995), 140-7), herein incorporated by reference, describes the CO₂ of solubility in 30% MEA solutions over a wide ranges of temperatures and pressures. A graph based on Jou's data of the two partial pressure curves v. loadings curves, at 120° C. and 60° C., is shown in FIG. 9, merely for the purpose of this discussion. Assuming CO₂ is absorbed into the amine solution at −60° C., in a gas power plant with MEA, one maximum solvent loading could be ˜0.45 mol/mol. This can be based on the liquid being not quite in equilibrium with the incoming gas (perhaps around 3% partial pressure of CO₂). The equilibrium condition is shown as point 1 in the figure. Normally, the amine can passed to a regenerator at a higher pressure (˜20 psig) and can be heated to −120° C. At this condition, the total pressure is comprised of water and CO₂ partial pressure. An estimate of water partial pressure at this condition shows that the CO₂ partial pressure must be around 20 kPa. This is shown as point 2 in the figure. The resulting CO₂ loading in solution is ˜0.31 mol/mol. Thus, by moving between the two points, 0.14 mol CO₂/mol amine can be removed (0.45-0.31=0.14 mol CO₂/mol of amine). This roughly corresponds to studies that have shown the optimal heat input into these systems gives a lean loading of ˜0.3.

If the liquid is shifted to a second vessel, e.g. a stripper, which uses a hot stripping gas, the loading can be lowered. This can be achieved through a combination of lowering the operating pressure of the vessel and introducing a stripping gas, e.g. methane, natural gas fuel, etc., to lower the partial pressure of CO₂. Assuming that the partial pressure of CO₂ could be reduced by about 90%, and a constant temperature maintained, the lean amine loading would be lowered by another 0.04 mol CO₂/mol amine. (Point 3). As a result, less mols of amine can be needed in circulation to get the same CO₂ removal (0.04/0.14=28%). As a first approximation, the circulation rate could be lower by 28%. With a lower circulation rate, less heat is required to regenerate the solvent. Alternatively, the stripper temperature could be lowered while maintaining the same circulation rate. Moreover, the CO₂ which is stripped out by the fuel gas can be returned to the gas turbine as a gas recycle. This raises the concentration of CO₂ going to the absorber and makes capture easier.

Several advantages can be realized based on this disclosure. The use of stripping gas in an independent polishing stage, separate from the regeneration, reduces the heat duty and heat quality required, thereby lowering the parasitic power consumption of the process. The lower energy requirement reduces the size of associated equipment such as reboilers. The CO₂ removed by the stripping gas can be recycled to the combustion step. This recycle can be similar to an exhaust gas recycle and can increase the CO₂ concentration in the flue gas, improving efficiency of the capture process with little impact on the power cycle.

An embodiment of the disclosure can be a system for removing carbon dioxide from a rich CO₂-absorbent using a regenerator and a stripper. The regenerator can be configured to remove a portion of the CO₂ from a rich CO₂-absorbent to produce a semi-lean CO₂-absorbent. The stripper can be configured to contact at least a portion of a stripping gas with the semi-lean CO₂-absorbent to remove at least a portion of the CO₂ from the semi-lean CO₂-absorbent to produce a lean absorbent and a CO₂-enriched stripping gas.

Alternatively, the stripper can be configured to remove a least a portion of the CO₂ from the rich CO₂-absorbent by contacting the rich CO₂-absorbent with at least a portion of a stripping gas to produce a semi-lean CO₂-absorbent and CO₂-enriched stripping gas. The regenerator can then be configured to remove the CO₂ from a semi-lean CO₂-absorbent to produce a lean absorbent.

As used herein, the term CO₂-absorbent means a CO₂ gas absorbed into an absorbent; in other words, the mixture that results from contacting a gas stream containing CO₂ gas with an absorbent, primarily a liquid absorbent. The term CO₂-absorbent can also include a CO₂-enriched absorbent, a CO₂-absorbent complex, or a CO₂-absorbent mixture.

The modifiers rich, semi-lean and lean indicate the amount of CO₂ present in the absorbent. For example, the absorbent that exits an absorber can be a rich absorbent, or a rich CO₂-absorbent. Conversely, a lean absorbent, or a lean CO₂-absorbent, can be an absorbent containing a limited amount of CO₂. Generally, the absorbent that enters an absorber at the end furthest from the CO₂ feed in a countercurrent absorber is a lean absorbent, and the absorbent leaving an absorber (a single stage absorber), where the absorbent is in equilibrium with inlet flue gas, is the rich absorbent. A semi-lean absorbent can be an absorbent that contains some amount of CO₂, but which has been reduced between the amount in the rich absorbent and the amount in the lean absorbent.

While the terms are relative, one of ordinary skill in the art would understand that a rich absorbent can be converted to a semi-lean absorbent by removing a portion of the CO₂, and the semi-lean absorbent can be converted to a lean absorbent by removing an additional amount of the CO₂ in the absorbent. At the two theoretical extremes can be a rich absorbent that is completely saturated in CO₂, and a lean absorbent that is completely devoid of CO₂. However, as a practical matter, neither of these theoretical extremes is attainable in a commercial process. An absorbent saturated in CO₂ would cause breakouts in a process and upset the flows in the process. An absorbent completely devoid of CO₂ would require extensive processing, potentially under high heat loads and/or under vacuum, neither of which is practicable in an industrial setting. Moreover, the specific concentration of CO₂ in an absorbent will depend on many factors, including the type the absorbent, temperature, concentration, solvent, operating conditions, and so forth. Thus one of skill in the art would understand that these terms are not defined based on the absolute capacity of these absorbents, but instead can be discussed in terms of their operational capacities.

The terms rich absorbent, semi-lean absorbent, and lean absorbent can be described in terms of the cyclic capacity. The cyclic capacity in the process can be the range from the operational minimum amount of CO₂ in the absorbent, i.e. the lean absorbent, to the operational maximum amount of CO₂ in the absorbent, i.e. the rich absorbent. In an embodiment, the rich absorbent can be the absorbent having a CO₂ content of about 95% to about 100% of the cyclic capacity, about 96% to about 100% of the cyclic capacity, about 97% to about 100% of the cyclic capacity, about 98% to about 100% of the cyclic capacity, about 99% to about 100% of the cyclic capacity, or preferably about 100% of the cyclic capacity. The lean absorbent can be the absorbent having a CO₂ content of about 0% to about 5% of the cyclic capacity, about 0% to about 4% of the cyclic capacity, about 0% to about 3% of the cyclic capacity, about 0% to about 2% of the cyclic capacity, about 0% to about 1% of the cyclic capacity, or preferably about 0% of the cyclic capacity. The semi-lean absorbent can be an absorbent having a CO₂ content of about 5% to about 95% of the cyclic capacity. In an embodiment when the regenerator precedes the stripper, the semi-lean absorbent can be about 5% to about 30% of the cyclic capacity, about 5% to about 25% of the cyclic capacity, about 5% to about 20% of the cyclic capacity, about 5% to about 15% of the cyclic capacity, about 10% to about 30% of the cyclic capacity, about 10% to about 25% of the cyclic capacity, or about 10% to about 20% of the cyclic capacity. In an embodiment when the stripper precedes the regenerator, the semi-lean absorbent can be about 70% to about 95% of the cyclic capacity, about 75% to about 95% of the cyclic capacity, about 80% to about 95% of the cyclic capacity, about 75% to about 90% of the cyclic capacity, or about 80% to about 90% of the cyclic capacity.

The absorbent can be any absorbent capable of absorbing CO₂ and being transported in a liquid. In an embodiment, the absorbent can be an amine. The amine can be any amine or mixture of amines capable of being transported in a liquid, preferably transported in water. Some common amine absorbents can include but not limited to MEA (monoethanolamine), MDEA (methyldiethanolamine), PZ (piperazine), DEA (diethanolamine), DGA (diglycolamine), and combinations thereof. Several classes of amines include primary, secondary, tertiary, and hindered amines, and blends thereof can be used. Similarly, the CO₂-absorbent can be a CO₂-amine or a CO₂-enriched amine.

The stripping gas can be any gas suitable for use in a gas stripping system. In an embodiment, the gas can be air, nitrogen, O₂-depleted air, or a fuel gas, or a mixture thereof. Preferably, the stripping gas can be a fuel gas. The fuel gas can be a combustible organic fuel, such as methane, ethane, propane, and mixtures thereof. The fuel gas can preferably be natural gas. In an embodiment, the stripping gas can be a rejected nitrogen stream from an air separation unit.

In an embodiment, the regenerator can be configured to thermally remove a portion of the CO₂ from the CO₂-absorbent to produce the semi-lean CO₂-absorbent. The desorption process in this case is a thermal swing absorption, where the CO₂ in the absorbent is driven out of solution via an increase in heat. The regenerator can be any device that can drive CO₂ from the CO₂-absorbent mixture.

The regenerator and stripper can be part of a larger system. In an embodiment, the system can further comprise an absorber. The absorber can be configured to contact at least portion of a flue gas with an absorbent to produce the CO₂-absorbent. The flue gas can be any flue gas from a combustion process. In an embodiment, the flue gas can be from a natural gas combustion process. Thus, in an embodiment, the system can also include a combustor configured to produce the flue gas.

In general, the absorber can operate according the processes typically used by one of ordinary skill in the art for absorbing CO₂ on an absorbent. In an embodiment, a lean absorbent can be added to one end of the absorber, typically the top end, and the flue gas can be added to an opposite end of the absorber, and the two can flow countercurrently passed each other, using the changing concentration gradient to achieve optimal absorption. In another embodiment, a semi-lean CO₂-absorbent that can be at least partially diverted from the first CO₂ desorption step can be fed into the absorber as well, preferably at some intermediate point between the lean absorbent entry point and the CO₂ absorbent entry point. Thus, in an embodiment, the absorber is configured to contact at least a portion of the flue gas with at least one of the cooled semi-lean CO₂-absorbent and the cooled lean absorbent to produce a CO₂-absorbent.

The lean absorbent and the semi-lean absorbent can each optionally be cooled prior to entering the absorber. In an embodiment, the system can further include at least one cooler configured to reduce the temperature of at least one of the semi-lean CO₂-absorbent and the lean absorbent to produce at least one of a cooled semi-lean CO₂-absorbent and a cooled lean absorbent. The absorber can be configured to receive either or both of the cooled semi-lean CO₂-absorbent and the cooled lean absorbent.

One advantage of the disclosure includes producing two CO₂ streams, one from the regenerator and one from the stripper, which can each be used in an energy efficient manner. The CO₂ stream from the regenerator can be predominately CO₂ and some water, and can be easily processed, condensed, sequestered, transferred, transported, pipelined, etc., thereby capturing at least a portion of the carbon created in a combustion process.

The CO₂ stream from the stripper can also be handled to improve carbon capture without additional thermal energy cost. In an embodiment, the CO₂-enriched stripping gas can be recycled to a front part of the process. In a preferred embodiment, the CO₂-enriched stripping gas can be fed into the combustor. This embodiment can be preferred particularly when the stripping gas is a fuel gas. A portion of the fuel gas used in combustion can be first diverted to the stripper, used to strip the CO₂ from the absorbent, and then fed into the combustor. Thus, the fuel value of the fuel gas can be reclaimed, and an additional stream for processing is not required. Moreover, the CO₂ concentration of the flue gas can be increased by the recycled CO₂ in the fuel gas, which can potentially increase the efficiency of the absorber and the regenerator.

The disclosure can also include an overall system for capturing the carbon dioxide product from a combustion process. The system can include a combustor configured to produce a flue gas from a fuel gas, an absorber configured to contact at least a portion of the flue gas with an absorbent to produce a CO₂-absorbent, a regenerator configured to remove a portion of CO₂ from the CO₂-absorbent to produce a semi-lean CO₂-absorbent; and a stripper configured to contact a fuel gas with the semi-lean CO₂-absorbent to remove at least a portion of the CO₂ from the semi-lean CO₂-absorbent to produce a lean absorbent and a CO₂-enriched fuel gas. The combustor can be further configured to receive the CO₂-enriched fuel gas, and wherein the absorber can be further configured to receive the lean absorbent. The aspects discussed above apply equally to this system.

The disclosure also provides for a method of removing CO₂ from a CO₂-absorbent, including the steps of removing a portion of the CO₂ from a CO₂-absorbent with a regenerator and removing a portion of the CO₂ by contacting a stripping gas with the CO₂-absorbent. In some embodiments, the method includes removing a portion of CO₂ from the rich CO₂-absorbent mixture to produce a semi-lean CO₂-absorbent mixture, and contacting a fuel gas with the semi-lean CO₂-absorbent to remove at least a portion of the CO₂ from the semi-lean CO₂-absorbent to produce a lean absorbent and a CO₂-enriched stripping gas. In alternate embodiments, the stripping step can be conducted first, with contacting a stripping gas with the rich CO₂-absorbent to remove a portion of CO₂ from the rich CO₂-absorbent mixture and produce a semi-lean CO₂-absorbent mixture, and then removing the CO₂ from the semi-lean CO₂-absorbent to produce a lean absorbent and a CO₂ gas stream. As in the discussion of the system above, the regenerator step, where the portion of the CO₂ is removed from either the rich CO₂-absorbent or the semi-lean CO₂-absorbent, can include heating the CO₂ absorbent to thermally desorb the CO₂.

The method can also include combusting at least one of a fuel gas and the CO₂-enriched stripping gas, preferably a CO₂₋enriched fuel gas, to produce a flue gas. The flue gas can be contacted with an absorbent to produce the CO₂-absorbent. The absorbent can be a lean absorbent, and semi-lean absorbent, or both. The method can also including cooling at least one of the semi-lean absorbent and the lean absorbent to produce at least one of a cooled semi-lean absorbent and a cooled lean absorbent, which can be contacted with the flue gas.

The method can also be a method for removing carbon dioxide (CO₂) from a combustion process. The method can include contacting at least a portion of a flue gas from a combustion process with an absorbent to produce a rich CO₂-absorbent, removing a portion of CO₂ from the CO₂-absorbent to produce a semi-lean CO₂-absorbent; and contacting a fuel gas with the semi-lean CO₂-absorbent to remove at least a portion of the CO₂ from the semi-lean CO₂-absorbent to produce a lean absorbent and a CO₂-enriched fuel gas; and combusting at least one of the CO₂-enriched fuel gas and a lean fuel gas to produce the flue gas.

### EMBODIMENTS

Additionally, or alternately, the disclosure can include one or more of the following embodiments.

### Embodiment 1

A system for removing carbon dioxide from a rich CO₂-absorbent comprising a regeneration stage and a stripping stage, wherein the regeneration stage is configured to thermally remove at least a portion of the CO₂ from the CO₂-absorbent, and wherein the stripping stage is configured to contact a stripping gas with the CO₂-absorbent to remove at least a portion of the CO₂ as a CO₂-stripping gas mixture, such that the rich CO₂-absorbent mixture is converted to a lean absorbent via a semi-lean CO₂-absorbent.

### Embodiment 2

A system for removing carbon dioxide (CO₂) from a CO₂-absorbent comprising a regenerator configured to remove a portion of CO₂ from a CO₂-absorbent to produce a semi-lean CO₂-absorbent; and a stripper configured to contact at least a portion of a fuel gas with the semi-lean CO₂-absorbent to remove at least a portion of the CO₂ from the semi-lean CO₂-absorbent to produce a lean absorbent and a CO₂-enriched fuel gas.

### Embodiment 3

A system for removing carbon dioxide (CO₂) from a flue gas comprising a combustor configured to produce a flue gas; an absorber configured to contact at least a portion of the flue gas with an absorbent to produce a CO₂-absorbent; a regenerator configured to remove a portion of CO₂ from the CO₂-absorbent to produce a semi-lean CO₂-absorbent; and a stripper configured to contact a fuel gas with the semi-lean CO₂-absorbent to remove at least a portion of the CO₂ from the semi-lean CO₂-absorbent to produce a lean absorbent and a CO₂-enriched fuel gas; wherein the combustor is further configured to receive the CO₂-enriched fuel gas, and wherein the absorber is further configured to receive the lean absorbent.

### Embodiment 4

A method for removing carbon dioxide (CO₂) from a CO₂-absorbent comprising removing a portion of CO₂ from the CO₂-absorbent to produce a semi-lean CO₂-absorbent; and contacting a fuel gas with the semi-lean CO₂-absorbent to remove at least a portion of the CO₂ from the semi-lean CO₂-absorbent to produce a lean absorbent and a CO₂-enriched fuel gas.

### Embodiment 5

A method for removing carbon dioxide (CO₂) from a flue gas comprising contacting at least a portion of a flue gas with an absorbent to produce a CO₂-absorbent; removing a portion of CO₂ from the CO₂-absorbent to produce a semi-lean CO₂-absorbent; and contacting a fuel gas with the semi-lean CO₂-absorbent to remove at least a portion of the CO₂ from the semi-lean CO₂-absorbent to produce a lean absorbent and a CO₂-enriched fuel gas; and combusting at least one of the CO₂-enriched fuel gas and a lean fuel gas to produce the flue gas.

### Embodiment 6

The systems and methods of any of these embodiments, wherein the regenerator is configured to thermally remove a portion of the CO₂ from the CO₂-absorbent to produce the semi-lean CO₂-absorbent, or wherein removing a portion of CO₂ from the CO₂-absorbent to produce the semi-lean CO₂-absorbent comprises heating the CO₂-absorbent.

### Embodiment 7

The systems and methods of any of these embodiments, further comprising an absorber configured to contact at least a portion of a flue gas with an absorbent to produce the CO₂-absorbent, or further comprising contacting at least a portion of the flue gas with an absorbent to produce the CO₂-absorbent.

### Embodiment 8

The systems and methods of any of these embodiments, wherein the regeneration stage precedes the stripping stage, and the regeneration stage removes CO₂ and converts the rich CO₂-absorbent to the semi-lean CO₂ absorbent, and the stripping stage converts the semi-lean CO₂-absorbent to the lean absorbent; or wherein the stripping stage precedes regeneration stage, and the stripping stage removes CO₂ and converts the rich CO₂-absorbent to the semi-lean CO₂-absorbent, and the regeneration stage converts the semi-lean CO₂-absorbent to the lean absorbent.

### Embodiment 9

The systems and methods of any of these embodiments, wherein removing a portion of CO₂ from the CO₂-absorbent to produce a semi-lean CO₂-absorbent comprises converting the CO₂-adsorbent having about 95% to about 100% of the cyclic capacity of the absorbent to the semi-lean adsorbent having about 5% to about 30% of the cyclic capacity of the absorbent, or to the semi-lean adsorbent having about 5% to about 25% of the cyclic capacity of the absorbent, or to the semi-lean adsorbent having about 5 to about 20% of the cyclic capacity of the absorbent, or to the semi-lean adsorbent having about 5 to about 15% of the cyclic capacity of the absorbent.

### Embodiment 10

The systems and methods of any of these embodiments, wherein the semi-lean adsorbent comprises about 5 to about 30% of the cyclic capacity of the absorbent, or about 5 to about 25%, about 5 to about 20%, or about 5 to about 15%.

### Embodiment 11

The systems and methods of any of these embodiments, wherein the stripping gas is a fuel gas.

### Embodiment 12

The systems and methods of any of these embodiments, wherein the fuel gas comprises a natural gas.

### Embodiment 13

The systems and methods of any of these embodiments, wherein the CO₂-absorbent is a CO₂-enriched amine.

### Embodiment 14

The systems and methods of any of these embodiments, wherein the semi-lean CO₂-absorbent comprises about 70 to about 95% of the cyclic capacity, or about 75% to about 95%, or about 80% to about 95%.

### Embodiment 15

The systems and methods of any of these embodiments, further comprising a combustor, or combustion chamber, configured to produce the flue gas at least one of a fuel gas, or a stripping gas, or a CO₂-enriched fuel gas; or further comprising combusting at least one of a fuel gas and the CO₂-enriched fuel gas to produce a flue gas.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

We claim:

1. A system for removing carbon dioxide (CO₂) from a CO₂-absorbent comprising:
a regenerator configured to remove a portion of CO₂ from a CO₂-absorbent to produce a semi-lean CO₂-absorbent; and
a stripper configured to contact at least a portion of a fuel gas with the semi-lean CO₂-absorbent to remove at least a portion of the CO₂ from the semi-lean CO₂-absorbent to produce a lean absorbent and a CO₂-enriched fuel gas.

2. The system of claim 1, wherein the regenerator is configured to thermally remove a portion of the CO₂ from the CO₂-absorbent to produce the semi-lean CO₂-absorbent.

3. The system of claim 1, further comprising an absorber configured to contact at least a portion of a flue gas with an absorbent to produce the CO₂-absorbent.

4. The system of claim 3, further comprising at least one cooler configured to reduce the temperature of at least one of the semi-lean CO₂-absorbent and the lean absorbent to produce at least one of a cooled semi-lean CO₂-absorbent and a cooled lean absorbent.

5. The system of claim 4, wherein the absorber is configured to receive at least one of the cooled semi-lean CO₂-absorbent and the cooled lean absorbent.

6. The system of claim 5, wherein the absorber is configured to contact at least a portion of the flue gas with at least one of the cooled semi-lean CO₂-absorbent and the cooled lean absorbent to produce a CO₂-absorbent.

7. The system of claim 3, further comprising a combustor configured to produce the flue gas.

8. The system of claim 7, wherein the combustor is further configured to receive the CO₂-enriched fuel gas.

9. The system of claim 1, wherein the CO₂-absorbent comprises a CO₂-enriched amine.

10. The system of claim 1, wherein the fuel gas comprises a natural gas.

11. The system of claim 1, wherein the semi-lean adsorbent comprises about 5 to about 30% of the cyclic capacity of the absorbent.

12. The system of claim 1, wherein the semi-lean adsorbent comprises about 5 to about 25% of the cyclic capacity of the absorbent.

13. A method for removing carbon dioxide (CO₂) from a CO₂-absorbent comprising:
removing a portion of CO₂ from the CO₂-absorbent to produce a semi-lean CO₂-absorbent; and
contacting a fuel gas with the semi-lean CO₂-absorbent to remove at least a portion of the CO₂ from the semi-lean CO₂-absorbent to produce a lean absorbent and a CO₂-enriched fuel gas.

14. The method of claim 13, wherein removing a portion of CO₂ from the CO₂-absorbent to produce the semi-lean CO₂-absorbent comprises heating the CO₂-absorbent.

15. The method of claim 13, further comprising combusting at least one of a fuel gas and the CO₂-enriched fuel gas to produce a flue gas.

16. The method of claim 15, further comprising contacting at least a portion of the flue gas with an absorbent to produce the CO₂-absorbent.

17. The method of claim 13, further comprising cooling at least one of the semi-lean CO₂-absorbent and the lean absorbent to produce at least one of a cooled semi-lean CO₂-absorbent and a cooled lean absorbent.

18. The method of claim 17, further comprising contacting at least a portion of the flue gas with at least one of the cooled semi-lean CO₂-absorbent and the cooled lean absorbent to produce a CO₂-absorbent.

19. The method of claim 13, wherein the CO₂-absorbent is a CO₂-enriched amine.

20. The method of claim 13, wherein the fuel gas is a natural gas.

21. The method of claim 13, wherein the removing a portion of CO₂ from the CO₂-absorbent to produce a semi-lean CO₂-absorbent comprises converting the CO₂-adsorbent having about 95% to about 100% of the cyclic capacity of the absorbent to the semi-lean adsorbent having about 5% to about 30% of the cyclic capacity of the absorbent.

22. The method of claim 13, wherein the removing a portion of CO₂ from the CO₂-absorbent to produce a semi-lean CO₂-absorbent comprises converting the CO₂-adsorbent having about 95% to about 100% of the cyclic capacity of the absorbent to the semi-lean adsorbent having about 5% to about 25% of the cyclic capacity of the absorbent.

23. A system for removing carbon dioxide (CO₂) from a flue gas comprising:
a combustor configured to produce a flue gas;
an absorber configured to contact at least a portion of the flue gas with an absorbent to produce a CO₂-absorbent;
a regenerator configured to remove a portion of CO₂ from the CO₂-absorbent to produce a semi-lean CO₂-absorbent; and
a stripper configured to contact a fuel gas with the semi-lean CO₂-absorbent to remove at least a portion of the CO₂ from the semi-lean CO₂-absorbent to produce a lean absorbent and a CO₂-enriched fuel gas;
wherein the combustor is further configured to receive the CO₂-enriched fuel gas, and wherein the absorber is further configured to receive the lean absorbent.

24. The system of claim 23, wherein the regenerator is configured to thermally remove a portion of the CO₂ from the CO₂-absorbent to produce the semi-lean CO₂-absorbent.

25. The system of claim 23, wherein the CO₂-absorbent comprises a CO₂-enriched amine.

26. The system of claim 23, wherein the fuel gas comprises a natural gas.

27. The system of claim 23, wherein the semi-lean adsorbent comprises about 5 to about 30% of the cyclic capacity of the absorbent.

28. The system of claim 23, wherein the semi-lean adsorbent comprises about 5 to about 25% of the cyclic capacity of the absorbent.

29. A method for removing carbon dioxide (CO₂) from a flue gas comprising:
contacting at least a portion of a flue gas with an absorbent to produce a CO₂-absorbent;
removing a portion of CO₂ from the CO₂-absorbent to produce a semi-lean CO₂-absorbent; and
contacting a fuel gas with the semi-lean CO₂-absorbent to remove at least a portion of the CO₂ from the semi-lean CO₂-absorbent to produce a lean absorbent and a CO₂-enriched fuel gas; and
combusting at least one of the CO₂-enriched fuel gas and a lean fuel gas to produce the flue gas.

30. The method of claim 29, wherein removing a portion of CO₂ from the CO₂-absorbent to produce the semi-lean CO₂-absorbent comprises heating the CO₂-absorbent.

31. The method of claim 29, further comprising combusting at least one of a fuel gas and the CO₂-enriched fuel gas to produce a flue gas.

32. The method of claim 31, further comprising contacting at least a portion of the flue gas with an absorbent to produce the CO₂-absorbent.

33. The method of claim 29, wherein the CO₂-absorbent comprises a CO₂-enriched amine.

34. The method of claim 29, wherein the fuel gas comprises a natural gas.

35. The method of claim 29, wherein the removing a portion of CO₂ from the CO₂-absorbent to produce a semi-lean CO₂-absorbent comprises converting the CO₂-adsorbent having about 95% to about 100% of the cyclic capacity of the absorbent to the semi-lean adsorbent having about 5% to about 30% of the cyclic capacity of the absorbent.

36. The method of claim 35, wherein the CO₂-adsorbent having about 95% to about 100% of the cyclic capacity of the absorbent is converted to the semi-lean adsorbent having about 5 to about 25% of the cyclic capacity of the absorbent.

37. A system for removing carbon dioxide from a rich CO₂-absorbent comprising a regeneration stage and a stripping stage,
wherein the regeneration stage is configured to thermally remove at least a portion of the CO₂ from the CO₂-absorbent, and
wherein the stripping stage is configured to contact a stripping gas with the CO₂-absorbent to remove at least a portion of the CO₂ as a CO₂-stripping gas mixture,
such that the rich CO₂-absorbent mixture is converted to a lean absorbent via a semi-lean CO₂-absorbent.

38. The system of claim 37, wherein the stripping gas is a fuel gas.

39. The system of claim 37, wherein the regeneration stage precedes the stripping stage, and the regeneration stage removes CO₂ and converts the rich CO₂-absorbent to the semi-lean CO₂-absorbent, and the stripping stage converts the semi-lean CO₂-absorbent to the lean absorbent.

40. The system of claim 39, wherein the semi-lean CO₂-absorbent comprises about 5 to about 30% of the cyclic capacity of the adsorbent.

41. The system of claim 37, wherein the stripping stage precedes regeneration stage, and the stripping stage removes CO₂ and converts the rich CO₂-absorbent to the semi-lean CO₂-absorbent, and the regeneration stage converts the semi-lean CO₂-absorbent to the lean absorbent.

42. The system of claim 41, wherein the semi-lean CO₂-absorbent comprises about 70 to about 95% of the cyclic capacity.

43. The system of claim 37, further comprising an absorber configured to contact at least a portion of a flue gas with an absorbent to produce the CO₂-absorbent.

44. The system of claim 43, further comprising a combustor configured to produce the flue gas.

45. The system of claim 44, wherein the CO₂ stripping gas mixture is a CO₂ fuel gas mixture, and the combustor is further configured to receive the CO₂ fuel gas mixture.
